(19) United States
(12) Patent Application Publication
(10) Pub. No.: US 2025/0140824 A1
(43) Pub. Date: May 1, 2025

(54) CATHODE ACTIVE MATERIAL FOR LITHIUM SECONDARY BATTERIES HAVING A MULTIPHASE STRUCTURE AND A MANUFACTURING METHOD THEREOF

(71) Applicants: HYUNDAI MOTOR COMPANY, Seoul (KR); KIA CORPORATION, Seoul (KR); UNIST (ULSAN NATIONAL INSTITUTE OF SCIENCE AND TECHNOLOGY), Ulsan (KR)

(72) Inventors: Je Sik Park, Seoul (KR); Hong Seok Min, Yongin-si (KR); Sung Woo Noh, Seoul (KR); Jeong Hyun Seo, Daejeon (KR); Im Sul Seo, Cheongju-si (KR); Ju Yeong Seong, Seongnam-si (KR); Chung Bum Lim, Suwon-si (KR); Dong Hwa Seo, Daejeon (KR); Eun Ryeol Lee, Ulsan (KR); Sang Wook Park, Daejeon (KR); Ho Joon Kim, Daejeon (KR)

(73) Assignees: HYUNDAI MOTOR COMPANY, Seoul (KR); KIA CORPORATION, Seoul (KR); UNIST (ULSAN NATIONAL INSTITUTE OF SCIENCE AND TECHNOLOGY), Ulsan (KR)

(21) Appl. No.: 18/411,860

(22) Filed: Jan. 12, 2024

(30) Foreign Application Priority Data
Oct. 30, 2023 (KR) 10-2023-0146476

(51) Int. Cl. H01M 4/505; C01G 45/12; H01M 4/02; H01M 10/052

(52) U.S. Cl. CPC H01M 4/505; C01G 45/1228; H01M 10/052; C01P 2002/32; C01P 2002/72; C01P 2006/40; H01M 2004/021

(57) ABSTRACT

A cathode active material for lithium secondary batteries having a multiphase structure and a manufacturing method thereof are disclosed. The cathode active material includes a lithium oxide according to the chemical formula Li₁₊ₓMn₂O₄ and having a multiphase structure including at least a cation-disordered rock salt (DRX) structure. In the formula, x satisfies the relationship 0≤x≤0.75.

### CROSS-REFERENCE TO RELATED APPLICATION

This application claims under 35 U.S.C. § 119 (a) the benefit of priority to Korean Patent Application No. 10-2023-0146476 filed on Oct. 30, 2023, the entire contents of which are incorporated herein by reference.

### BACKGROUND

### (a) Technical Field

The present disclosure relates to a cathode active material for lithium secondary batteries having a multiphase structure and to a manufacturing method thereof.

### (b) Background Art

Batteries are devices that store electric power using materials enabling electrochemical reaction in a cathode and an anode. As a representative example of a battery, a lithium secondary battery stores electrical energy using a chemical potential difference when lithium ions are intercalated into and deintercalated from a cathode and an anode.

Lithium (Li) oxide is used as a cathode active material of the lithium secondary battery. For example, LiCoO₂, LiMn₂O₄, LiMnO₂, LiNiO₂, and a nickel (Ni), cobalt (Co), manganese (Mn), or aluminum (AI) composite oxide may be employed as lithium oxides.

Lithium manganese oxides including LiMnO₂, LiMn₂O₄, and the like have advantages, such as excellent thermal stability and low price, but have drawbacks, such as a small capacity and poor high-temperature characteristics.

The above information disclosed in this Background section is only to enhance understanding of the background of the disclosure. Therefore, the Background section may contain information that does not form the prior art that is already known to a person of ordinary skill in the art.

### SUMMARY OF THE DISCLOSURE

The present disclosure has been made in an effort to solve the above-described problems associated with the prior art. It is an object of the present disclosure to provide a cathode active material for lithium secondary batteries having a multiphase structure. It is also an object of the present disclosure to provide a manufacturing method thereof.

In one aspect, the present disclosure provides a cathode active material for lithium secondary batteries. The cathode active material includes a lithium oxide represented by Chemical Formula 1 and having a multiphase structure including at least a cation-disordered rock salt (DRX) structure.

Li₁₊ₓMn₂O₄ Chemical Formula 1

In Chemical Formula 1, x satisfies the relationship 0≤x≤0.75.

In an embodiment, the cathode active material may include at least two of a layered structure, a spinel structure, or the DRX structure.

In another embodiment, the cathode active material may exhibit peaks at 2θ=19°±0.5°, 31°±0.5°, 36.5°±0.5°, 48.5°±0.5°, 55°±0.5°, 58.5°±0.5°, 67.5°±0.5°, 68.5°±0.5°, 76°±0.5° and 84°±0.5° in X-ray diffraction analysis using Cuk α radiation.

In still another embodiment, the cathode active material may exhibit peaks at 2θ=38°+0.5°, 44.5°+0.5°, 64.5°+0.5°, 77.5°+0.5° and 81°+0.5° in X-ray diffraction analysis using Cuk α radiation.

In yet another embodiment, a ratio (Aₛₚᵢₙₑₗ/Aₜₒₜₐₗ) of an area (Aₛₚᵢₙₑₗ) of peaks due to a spinel structure to a total area (Aₜₒₜₐₗ) of all peaks of the cathode active material exhibited in X-ray diffraction analysis using Cuk α radiation may be in a range of 0.1 to 99.8.

In still yet another embodiment, a ratio (A_{DRX}/Aₜₒₜₐₗ) of an area (A_{DRX}) of peaks due to the DRX structure to a total area (Aₜₒₜₐₗ) of all peaks of the cathode active material exhibited in X-ray diffraction analysis using Cuk α radiation may be in a range of 0.2 to 0.99.

In a further embodiment, the lithium oxide may include Li_{1.25}Mn₂O₄.

In another further embodiment, a ratio (Aₛₚᵢₙₑₗ/Aₜₒₜₐₗ) of the area (Aₛₚᵢₙₑₗ) of peaks due to a spinel structure to a total area (Aₜₒₜₐₗ) of all peaks of the cathode active material exhibited in X-ray diffraction analysis using Cuk α radiation may be in a range of 0.4 to 0.6.

In still another further embodiment, a ratio (A_{DRX}/Aₜₒₜₐₗ) of an area (A_{DRX}) of peaks due to the DRX structure to a total area (Aₜₒₜₐₗ) of all peaks of the cathode active material exhibited in X-ray diffraction analysis using Cuk α radiation may be in a range of 0.4 to 0.6.

In another aspect, the present disclosure provides a manufacturing method for a cathode active material for lithium secondary batteries having a multiphase structure including at least a cation-disordered rock salt (DRX) structure. The manufacturing method includes preparing raw materials, acquiring an intermediate substance by crushing the raw materials, and acquiring a lithium oxide represented by Chemical Formula 1 by heat-treating the intermediate substance.

In an embodiment, in acquiring the intermediate substance, the raw materials may be crushed by applying force in a range of 10 G to 20 G to the raw materials for 10 hours to 30 hours using a ball mill.

Other aspects and embodiments of the disclosure are discussed below.

The above and other features of the disclosure are also discussed below.

### BRIEF DESCRIPTION OF THE DRAWINGS

The above and other features of the present disclosure are described in detail with reference to certain example embodiments thereof illustrated in the accompanying drawings, which are given hereinbelow by way of illustration only, and thus are not limitative of the present disclosure, and wherein:

FIG. 1 shows a transmission electronic microscopy (TEM) image of a cathode active material according to Example 1;

FIG. 2 shows a TEM image of a cathode active material according to Example 3;

FIG. 3 shows a TEM image of a cathode active material according to Example 4;

FIG. 4 shows X-ray diffraction analysis of the cathode active material according to Example 1;

FIG. 5 shows X-ray diffraction analysis of a cathode active material according to Example 2;

FIG. 6 shows X-ray diffraction analysis of the cathode active material according to Example 3;

FIG. 7 shows X-ray diffraction analysis of the cathode active material according to Example 4;

FIG. 8 shows capacity and cycle life evaluation of a lithium secondary battery using the cathode active material according to Example 1;

FIG. 9 shows capacity and cycle life evaluation of a lithium secondary battery using the cathode active material according to Example 2;

FIG. 10 shows capacity and cycle life evaluation of a lithium secondary battery using the cathode active material according to Example 3; and

FIG. 11 shows capacity and cycle life evaluation of a lithium secondary battery using the cathode active material according to Example 4.

It should be understood that the appended drawings are not necessarily shown or drawn to scale, presenting a somewhat simplified representation of various features illustrative of the basic principles of the disclosure. The specific design features of the present disclosure as disclosed herein, including, for example, specific dimensions, orientations, locations, and shapes, will be determined in part by the particular intended application and use environment.

In the figures, the same reference numbers refer to the same or equivalent parts of the present disclosure throughout the several figures of the drawings.

### DETAILED DESCRIPTION

The above-described objects, other objects, advantages, and features of the present disclosure should become apparent from the descriptions of embodiments given hereinbelow with reference to the accompanying drawings. However, the present disclosure is not limited to the embodiments disclosed herein and may be implemented in various different forms. The embodiments are provided to make the description of the present disclosure thorough and to fully convey the scope of the present disclosure to those of ordinary skill in the art.

In the drawings, the same or similar elements are denoted by the same reference numerals even though they are depicted in different drawings. In the drawings, the dimensions of structures may be exaggerated compared to the actual dimensions thereof for clarity of description. In the following description of the embodiments, terms, such as “first” and “second”, may be used to describe various elements but do not limit the elements. These terms are used only to distinguish one element from other elements. For example, a first element may be named a second element, and similarly, a second element may be named a first element, without departing from the scope and spirit of the disclosure. Singular expressions may encompass plural expressions, unless they have clearly different contextual meanings.

In the following description of the embodiments, terms, such as “including”, “comprising” and “having”, are to be interpreted as indicating the presence of characteristics, numbers, steps, operations, elements, or parts stated in the description or combinations thereof. Such terms do not exclude the presence of one or more other characteristics, numbers, steps, operations, elements, parts, or combinations thereof, or possibility of adding the same. In addition, it should be understood that, when a part, such as a layer, a film, a region, or a plate, is said to be “on” another part, the part may be located “directly on” the other part or other parts may be interposed between the two parts. In the same manner, it should be understood that, when a part, such as a layer, a film, a region, or a plate, is said to be “under” another part, the part may be located “directly under” the other part or other parts may be interposed between the two parts.

All numbers, values, and/or expressions representing amounts of components, reaction conditions, polymer compositions, and blends used in the description are approximations in which various uncertainties in measurement, generated when these values are obtained from essentially different things, are reflected. Thus, it should be understood that these numbers, values, and/or expression are modified by the term “about”, unless stated otherwise. In addition, it should be understood that, if a numerical range is disclosed in the description, such a range includes all continuous values from a minimum value to a maximum value of the range, unless stated otherwise. Further, if such a range refers to integers, the range includes all integers from a minimum integer to a maximum integer, unless stated otherwise.

A cathode active material according to the present disclosure may include a lithium oxide represented by Chemical Formula 1 below.

Li₁₊ₓMn₂O₄ Chemical Formula 1

In Chemical Formula 1, x may satisfy the relationship 0≤x≤0.75.

The cathode active material may have a multiphase structure including at least a cation-disordered rock salt (DRX) structure. The cathode active material may include at least two of a layered structure, a spinel structure, or the cation-disordered rock salt (DRX) structure.

The cation-disordered rock salt (DRX) structure is a structure in which large anions are most densely stacked and all holes in octahedrons are filled with cations. The cation-disordered rock salt (DRX) structure has less electrical repulsive force than the layered structure in which anions and cations are alternately provided and is thus very stable. Therefore, a cathode active material having the cation-disordered rock salt (DRX) structure may undergo little volume change during charging and discharging and may enable intercalation and deintercalation of lithium ions through a similar mechanism to an Li-rich oxide.

The spinel structure forms octahedrons of oxygen ions similar to the layered structure, and transition metal ions are present therein. Lithium ions and the transition metal ions occupy tetrahedral (8a) and octahedral (16d) sites, respectively. Due to such structural characteristics, the spinel structure has a three-dimensional lithium ion diffusion path. Lithium ions may thereby be inserted into the spinel structure in various directions.

In the layered structure, a layer formed by a MO₂ structure (where M represents a metal) and a lithium ion layer are alternately stacked. In the MO₂ structure, octahedrons having transition metal ions occupying the centers thereof and oxygen ions occupying the vertices thereof share corners with each other. The layered structure has a two-dimensional lithium ion diffusion path, and thus has a high diffusion rate. Further, the layered structure has a broad storage space for lithium ions, and thus exhibits a high theoretical capacity.

As x, indicating the number of moles of lithium atoms in Chemical Formula 1, changes, a phase ratio of the cathode active material may be varied. When a cathode active material having a proper phase ratio is used, the energy density, cycle life, and the like of a lithium secondary battery including the cathode active material may be improved. This is described below with reference to Examples.

A lithium manganese oxide having a multiphase structure according to the present disclosure may not be manufactured through simple crushing and baking processes. A manufacturing method of a cathode active material for lithium secondary batteries according to the present disclosure may include preparing raw materials, acquiring an intermediate substance by crushing the raw materials using a high-energy planetary ball mill, and acquiring a lithium oxide represented by Chemical Formula 1 above by heat-treating the intermediate.

The raw materials may include a lithium precursor, a manganese precursor, and the like.

The lithium precursor is not limited to a specific substance and, for example, may include Li₂O, LiCO₃, LiNO₃, Li₃N, LiF, LiS, LiI, or the like.

The manganese is not limited to a specific substance and, for example, may include MnO₂, Mn₂O₃, Mn₃O₄, or the like.

The raw materials may be weighed to suit a desired composition of the lithium oxide and may be prepared.

Thereafter, the intermediate substance may be acquired by crushing the raw materials using the high-energy planetary ball mill not a general ball mill.

As the high-energy planetary ball mill, any device which is sold commercially may be used. For example, a device known as PM200 produced by RETSCH may be used.

In acquiring the intermediate substance, the raw materials may be crushed by applying force in a range of 10 G to 22 G, or in a range of 17 G to 22 G, thereto for 10 to 30 hours, or 25 to 30 hours, using the high-energy planetary ball mill. The cathode active material having the multiphase structure may be manufactured only when the above-described force and time ranges for the raw materials are satisfied.

The lithium oxide may be acquired by heat-treating the intermediate substance.

A heat treatment method and conditions are not limited to a specific method and conditions. Any method and conditions, which are generally used in the technical field to which the present disclosure pertains may be executed. For example, the heat treatment may be performed by placing the intermediate substance in a furnace and then heating the intermediate substance, or by applying microwaves to the intermediate substance.

Hereinafter, the present disclosure is described in more detail through the following Examples. The following Examples serve merely to describe, by way of example, the present disclosure, and are not intended to limit the scope and spirit of the disclosure.

### Example 1

A lithium oxide expressed as LiMn₂O₄ was manufactured. Raw materials were prepared by weighing a lithium precursor and a manganese precursor to suit the composition. Force of about 17.77 G was applied to the raw materials for about 25 hours by driving a high-energy planetary ball mill (PM200 produced by RETSCH) at about 450 rpm. The lithium oxide was acquired by heat-treating an intermediate substance acquired thereby.

### Example 2

A lithium oxide expressed as Li_{1.25}Mn₂O₄ was manufactured. Raw materials were prepared by weighing a lithium precursor and a manganese precursor to suit the composition. Thereafter, the lithium oxide was manufactured by the same method and conditions as in Example 1.

### Example 3

A lithium oxide expressed as Li_{1.5}Mn₂O₄ was manufactured. Raw materials were prepared by weighing a lithium precursor and a manganese precursor to suit the composition. Thereafter, the lithium oxide was manufactured by the same method and conditions as in Example 1.

### Example 4

A lithium oxide expressed as Li_{1.75}Mn₂O₄ was manufactured. Raw materials were prepared by weighing a lithium precursor and a manganese precursor to suit the composition. Thereafter, the lithium oxide was manufactured by the same method and conditions as in Example 1.

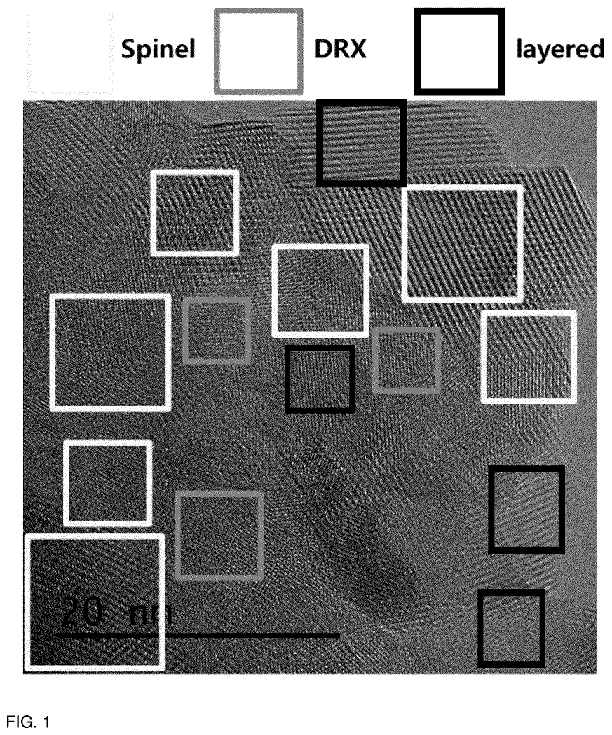

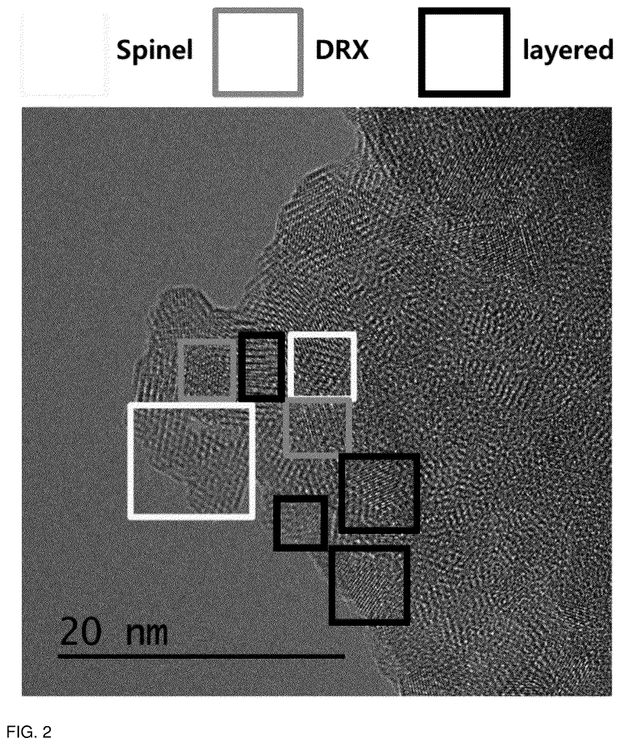

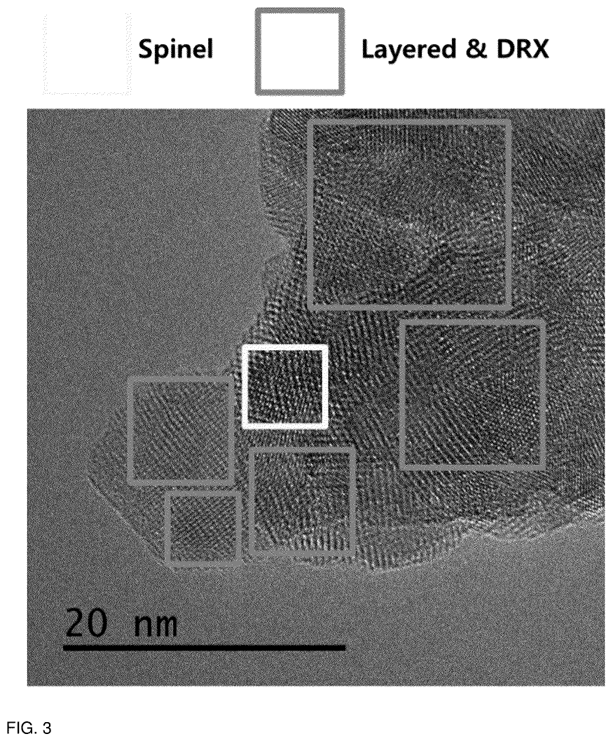

FIG. 1 shows a transmission electronic microscopy (TEM) image of the cathode active material according to Example 1. FIG. 2 shows a TEM image of the cathode active material according to Example 3. FIG. 3 shows a TEM image of the cathode active material according to Example 4.

Referring to FIGS. 1-3, in the cathode active materials according to the present disclosure, all the layered structure, the spinel structure, and the DRX structure uniformly appear.

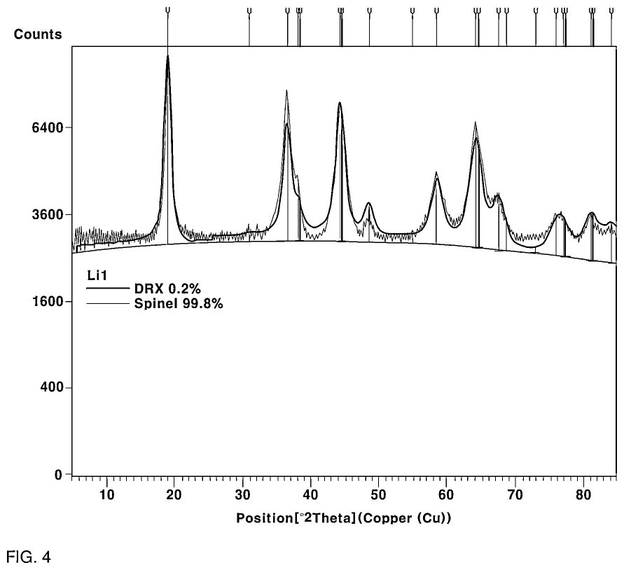

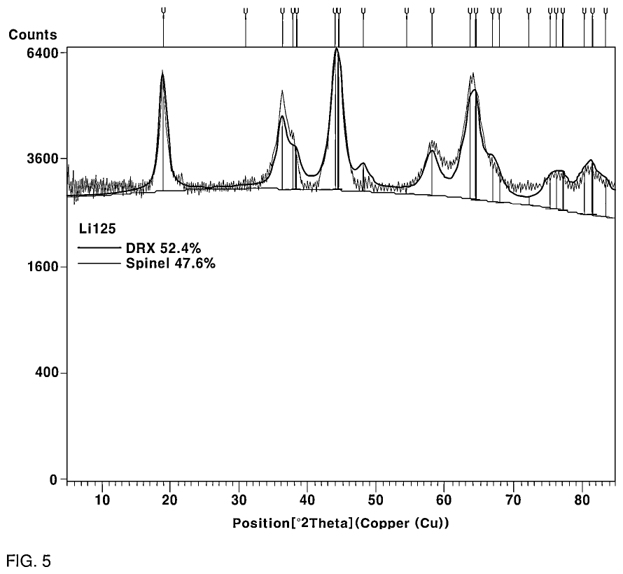

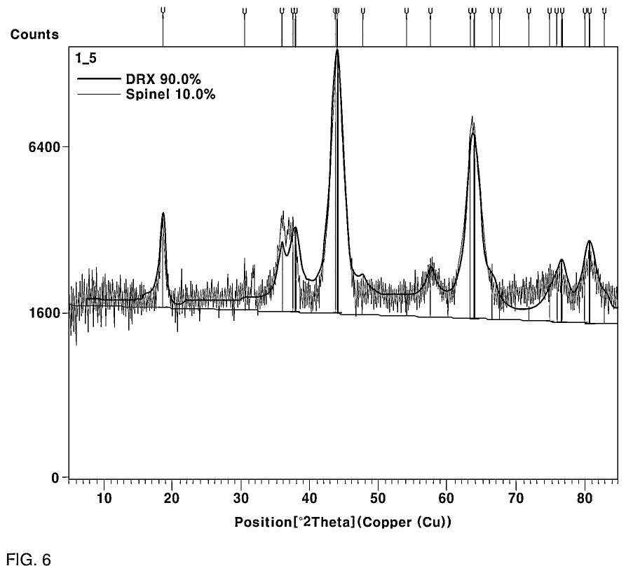

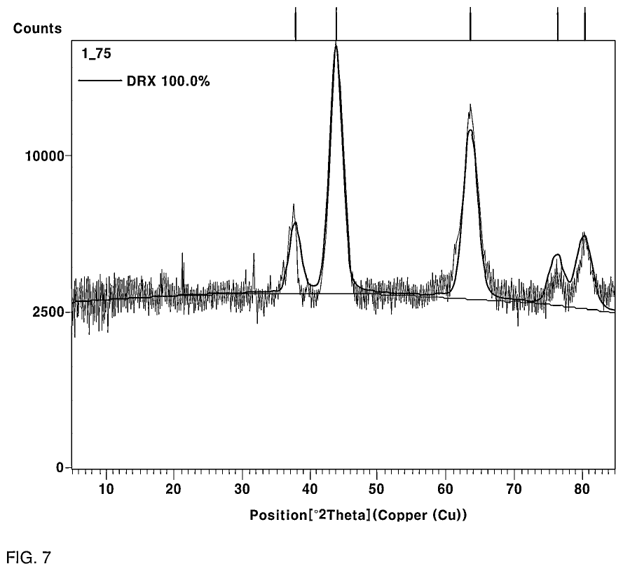

FIG. 4 shows X-ray diffraction analysis of the cathode active material according to Example 1. FIG. 5 shows X-ray diffraction analysis of the cathode active material according to Example 2. FIG. 6 shows X-ray diffraction analysis of the cathode active material according to Example 3. FIG. 7 shows X-ray diffraction analysis of the cathode active material according to Example 4.

Referring to FIGS. 4-6, the cathode active materials according to Examples 1-3 exhibit peaks due to the DRX structure and peaks due to the spinel structure.

The cathode active materials according to the present disclosure exhibit peaks at 2θ=19°±0.5°, 31°±0.5°, 36.5°±0.5°, 48.5°±0.5°, 55°±0.5°, 58.5°±0.5°, 67.5°±0.5°, 68.5°±0.5°, 76°±0.5° and 84°±0.5° in X-ray diffraction analysis using Cuk α radiation. These peaks are due to the spinel structure.

Further, the cathode active materials according to the present disclosure exhibit peaks at 2θ=38°±0.5°, 44.5°±0.5°, 64.5°±0.5°, 77.5°±0.5° and 81°±0.5° in X-ray diffraction analysis using Cuk α radiation. These peaks are due to the DRX structure.

Referring to FIG. 7, the cathode active material according to Example 4 does not exhibit peaks due to the spinel structure. However, the results of Example 4 are obtained due to the fact that the spinel phase is partially formed in the DRX structure as the value of x increases. Therefore, it is not that the spinel phase does not exist in the cathode active material according to Example 4.

The area ratios of the respective peaks are calculated based on the results of FIGS. 4-7 and are set forth in Table 1.

TABLE 1

| Category | Composition | A_{DRX}/Aₜₒₜₐₗ¹⁾ | Aₛₚᵢₙₑₗ/Aₜₒₜₐₗ²⁾ |
|---|---|---|---|
| Example 1 | LiMn₂O₄ | 0.2 | 99.8 |
| Example 2 | Li_{1.25}Mn₂O₄ | 52.4 | 47.6 |
| Example 3 | Li_{1.5}Mn₂O₄ | 90 | 10 |
| Example 4 | Li_{1.75}Mn₂O₄ | 100 | 0 |

The ratio A_{DRX}/Aₜₒₜₐₗ is a ratio of the area (A_{DRX}) of the peaks due to the DRX structure to the total area (Aₜₒₜₐₗ) of all the peaks exhibited in X-ray diffraction analysis using CuK α radiation

The ratio Aₛₚᵢₙₑₗ/Aₜₒₜₐₗ is a ratio of the area (Aₛₚᵢₙₑₗ) of the peaks due to the spinel structure to the total area (Aₜₒₜₐₗ) of all the peaks exhibited in X-ray diffraction analysis using CuK α radiation

As set forth in Table 1, in the cathode active materials according to the present disclosure, the ratio (Aₛₚᵢₙₑₗ/Aₜₒₜₐₗ) of the area (Aₛₚᵢₙₑₗ) of the peaks due to the spinel structure to the total area (Aₜₒₜₐₗ) of all the peaks exhibited in X-ray diffraction analysis using Cuk α radiation may be in a range of 0.1 to 99.8. Further, in the cathode active materials according to the present disclosure, the ratio (A_{DRX}/Aₜₒₜₐₗ) of the area (A_{DRX}) of the peaks due to the DRX structure to the total area (Aₜₒₜₐₗ) of all the peaks exhibited in X-ray diffraction analysis using Cuk α radiation may be in a ratio of 0.2 to 0.99.

Thereby, it may be confirmed that the cathode active materials according to the present disclosure have a multiphase structure.

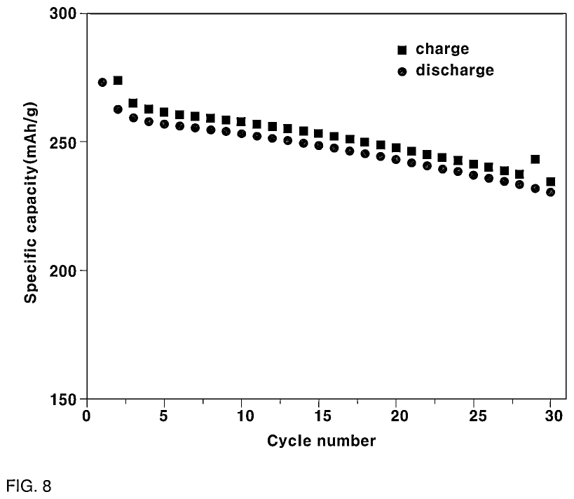

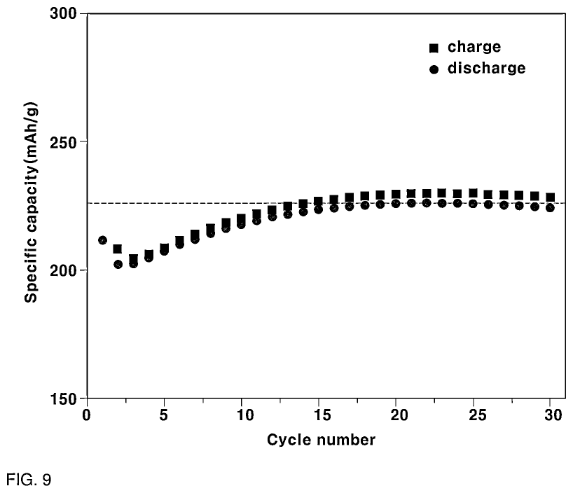

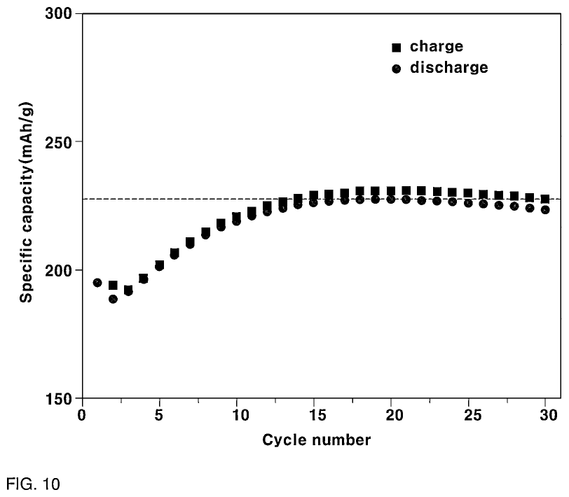

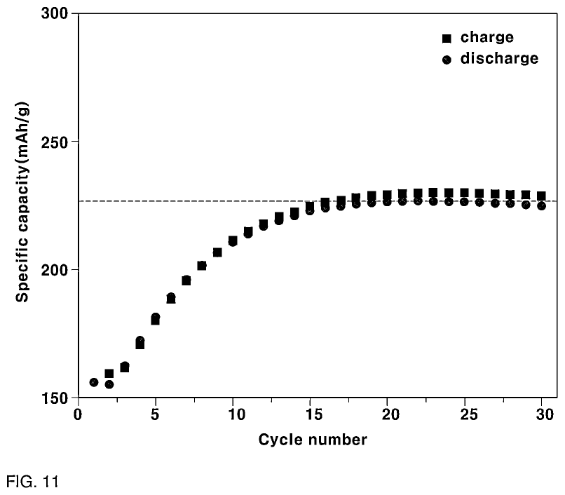

FIG. 8 shows capacity and cycle life evaluation of a lithium secondary battery using the cathode active material according to Example 1. FIG. 9 shows capacity and cycle life evaluation of a lithium secondary battery using the cathode active material according to Example 2. FIG. 10 shows capacity and cycle life evaluation of a lithium secondary battery using the cathode active material according to Example 3. FIG. 11 shows capacity and cycle life evaluation of a lithium secondary battery using the cathode active material according to Example 4.

The initial capacities and capacity retention rates of the respective lithium secondary batteries are set forth in Table 2 below.

TABLE 2

| Category | Example 1 | Example 2 | Example 3 | Example 4 |
|---|---|---|---|---|
| Composition | LiMn₂O₄ | Li_{1.25}Mn₂O₄ | Li_{1.5}Mn₂O₄ | Li_{1.75}Mn₂O₄ |
| A_{DRX}/Aₜₒₜₐₗ | 0.2 | 52.4 | 90 | 100 |
| Aₛₚᵢₙₑₗ/Aₜₒₜₐₗ | 99.8 | 47.6 | 10 | 0 |
| Initial capacity | 273 | 211 | 195 | 156 |
| [mAh/g] | | | | |
| Capacity @30 | 230 | 224 | 223 | 225 |
| cycle [mAh/g] | | | | |
| Capacity | 84.31% | 99.16% | 98.23% | 99.11% |
| retention rate | | | | |
| @30 cycle | | | | |
| Capacity @50 | 207 | 209 | 207 | 204 |
| cycle [mAh/g] | | | | |
| Capacity | 77.9% | 92.6% | 90.5% | 91.8% |
| retention rate | | | | |
| @50 cycle | | | | |

Referring to FIGS. 8-11 and Table 2, the lithium secondary battery according to Example 1 has high initial capacity and the lithium secondary battery according to Example 4 has an excellent capacity retention rate. Further, the lithium secondary battery expressed as Li_{1.25}Mn₂O₄ according to the present disclosure exhibits the best results.

As is apparent from the above description, the present disclosure provides a cathode active material for lithium secondary batteries having a multiphase structure and provides a manufacturing method thereof.

Further, the present disclosure provides a lithium secondary battery having improved energy density and cycle life.

The disclosure has been described in detail with reference to specific embodiments thereof. However, it should be appreciated by those of ordinary skill in the art that changes may be made in these embodiments without departing from the principles and spirit of the disclosure, the scope of which is defined in the appended claims and their equivalents.

What is claimed is:

1. A cathode active material for lithium secondary batteries, the cathode active material comprising:
a lithium oxide having a chemical formula Li₁₊ₓMn₂O₄, and having a multiphase structure comprising at least a cation-disordered rock salt (DRX) structure,
wherein x satisfies a relationship 0≤x≤0.75.

2. The cathode active material of claim 1, wherein the cathode active material comprises at least two of a layered structure, a spinel structure, or the DRX structure.

3. The cathode active material of claim 1, wherein the cathode active material exhibits peaks at 2θ=19°±0.5°, 31°±0.5°, 36.5°±0.5°, 48.5°±0.5°, 55°±0.5°, 58.5°±0.5°, 67.5°±0.5°, 68.5°±0.5°, 76°±0.5° and 84°±0.5° in X-ray diffraction analysis using Cuk α radiation.

4. The cathode active material of claim 1, wherein the cathode active material exhibits peaks at 2θ=38°±0.5°, 44.5°±0.5°, 64.5°±0.5°, 77.5°±0.5° and 81°±0.5° in X-ray diffraction analysis using Cuk α radiation.

5. The cathode active material of claim 1, wherein a ratio (Aₛₚᵢₙₑₗ/Aₜₒₜₐₗ) of an area (Aₛₚᵢₙₑₗ) of peaks due to a spinel structure to a total area (Aₜₒₜₐₗ) of all peaks of the cathode active material exhibited in X-ray diffraction analysis using Cuk α radiation is in a range of 0.1 to 99.8.

6. The cathode active material of claim 1, wherein a ratio (A_{DRX}/Aₜₒₜₐₗ) of an area (A_{DRX}) of peaks due to the DRX structure to a total area (Aₜₒₜₐₗ) of all peaks of the cathode active material exhibited in X-ray diffraction analysis using Cuk α radiation is in a range of 0.2 to 0.99.

7. The cathode active material of claim 1, wherein the lithium oxide comprises Li_{1.25}Mn₂O₄.

8. The cathode active material of claim 1, wherein a ratio (Aₛₚᵢₙₑₗ/Aₜₒₜₐₗ) of an area (Aₛₚᵢₙₑₗ) of peaks due to a spinel structure to a total area (Aₜₒₜₐₗ) of all peaks of the cathode active material exhibited in X-ray diffraction analysis using Cuk α radiation is 0.4 to 0.6.

9. The cathode active material of claim 1, wherein a ratio (A_{DRX}/Aₜₒₜₐₗ) of an area (A_{DRX}) of peaks due to the DRX structure to a total area (Aₜₒₜₐₗ) of all peaks of the cathode active material exhibited in X-ray diffraction analysis using Cuk α radiation is in a range of 0.4 to 0.6.

10. A manufacturing method of a cathode active material for lithium secondary batteries having a multiphase structure comprising at least a cation-disordered rock salt (DRX) structure, the manufacturing method comprising:
preparing raw materials;
acquiring an intermediate substance by crushing the raw materials; and
acquiring a lithium oxide according to a chemical formula Li₁₊ₓMn₂O₄ by heat-treating the intermediate substance,
wherein x satisfies a relationship 0≤x≤0.75.

11. The manufacturing method of claim 10, wherein, in acquiring the intermediate substance, the raw materials are crushed by applying a force in a range of 10 G to 20 G to the raw materials for 10 hours to 30 hours using a ball mill.

12. The manufacturing method of claim 10, wherein the cathode active material comprises at least two of a layered structure, a spinel structure, or the DRX structure.

13. The manufacturing method of claim 10, wherein the cathode active material exhibits peaks at 2θ=19°±0.5°, 31°±0.5°, 36.5°±0.5°, 48.5°±0.5°, 55°±0.5°, 58.5°±0.5°, 67.5°±0.5°, 68.5°±0.5°, 76°±0.5° and 84°±0.5° in X-ray diffraction analysis using Cuk α radiation.

14. The manufacturing method of claim 10, wherein the cathode active material exhibits peaks at 2θ=38°±0.5°, 44.5°±0.5°, 64.5°±0.5°, 77.5°±0.5° and 81°±0.5° in X-ray diffraction analysis using Cuk α radiation.

15. The manufacturing method of claim 10, wherein a ratio (Aₛₚᵢₙₑₗ/Aₜₒₜₐₗ) of an area (Aₛₚᵢₙₑₗ) of peaks due to a spinel structure to a total area (Aₜₒₜₐₗ) of all peaks of the cathode active material exhibited in X-ray diffraction analysis using Cuk α radiation is in a range of 0.1 to 99.8.

16. The manufacturing method of claim 10, wherein a ratio (A_{DRX}/Aₜₒₜₐₗ) of an area (A_{DRX}) of peaks due to the DRX structure to a total area (Aₜₒₜₐₗ) of all peaks of the cathode active material exhibited in X-ray diffraction analysis using Cuk α radiation is in a range of 0.2 to 0.99.

17. The manufacturing method of claim 10, wherein the lithium oxide comprises Li_{1.25}Mn₂O₄.

18. The manufacturing method of claim 10, wherein a ratio (Aₛₚᵢₙₑₗ/Aₜₒₜₐₗ) of an area (Aₛₚᵢₙₑₗ) of peaks due to a spinel structure to a total area (Aₜₒₜₐₗ) of all peaks of the cathode active material exhibited in X-ray diffraction analysis using Cuk α radiation is in a range of 0.4 to 0.6.

19. The manufacturing method of claim 10, wherein a ratio (A_{DRX}/Aₜₒₜₐₗ) of an area (A_{DRX}) of peaks due to the DRX structure to a total area (Aₜₒₜₐₗ) of all peaks of the cathode active material exhibited in X-ray diffraction analysis using Cuk α radiation is in a range of 0.4 to 0.6.
